(19) United States
(12) Patent Application Publication
(10) Pub. No.: US 2026/0280281 A1
(43) Pub. Date: Sep. 17, 2026

(54) POWER SUPPLY SYSTEM, AND CONTROLLING METHOD AND CONTROLLER THEREOF

(71) Applicant: Hitachi Energy Ltd, Zürich (CH)

(72) Inventors: Weichi ZHANG, Beijing (CN); Philippe NOISETTE, Plan-les-Ouates (CH); Philippe MAIBACH, Muhen (CH); XiaoBo YANG, Beijing (CH); Jan SVENSSON, Västerås (SE)

(21) Appl. No.: 19/469,055

(22) PCT Filed: May 10, 2023
(86) PCT No.: PCT/EP2023/062478

§ 371 Date: Sep. 25, 2025

(30) Foreign Application Priority Data
Mar. 30, 2023 (CN) 202310331712.0

(51) Int. Cl. H02J 1/08; H02J 1/10; H02J 1/102; H02J 105/50; H02M 1/00; H02M 3/26; H02M 3/335; H02M 7/08; H02M 7/162; H02M 7/17

(52) U.S. Cl. CPC H02J 1/084; H02J 1/102; H02J 1/106; H02M 1/007; H02M 3/26; H02M 3/33573; H02M 7/08; H02M 7/162; H02M 7/17; H02J 2105/51

(57) ABSTRACT

A power supply system for powering an electrolysis device is provided. The power supply system includes a converter unit comprising one or more converters, a transformer unit comprising one or more transformers coupled with the converter unit, a rectifier unit comprising a plurality of rectifiers. Each rectifier is coupled between one of the one or more transformers and one of a plurality of electrolysis stacks of the electrolysis device. The power supply system further includes a controller configured to control the converter unit and/or the rectifier unit to adjust a direct current supplied to at least one of the plurality of electrolysis stacks.

### TECHNICAL FILED

The disclosure relates to a power supply system for powering an electrolysis device. The disclosure also relates to a method and controller for controlling the power supply system to power the electrolysis device.

### BACKGROUND

As an energy carrier with multiple end-use applications, hydrogen plays an important role in the global energy transition. For example, hydrogen plays an important role in road transport, mining, shipping and aviation. Among various hydrogen production technologies, green hydrogen production technology using renewable energy such as wind or solar energy for water electrolysis is the most popular one, which helps to achieve carbon neutrality. Against such a background, the electrolyzer market is rapidly expanding in many countries. Correspondingly, there is an urgent need for a power supply system especially suitable for powering electrolyzers.

### SUMMARY

According to an embodiment of the disclosure, a power supply system for powering an electrolysis device is provided. The power supply system include: a converter unit comprising one or more converters; a transformer unit comprising one or more transformers coupled with the converter unit; a rectifier unit comprising a plurality of rectifiers, each rectifier being coupled between one of the one or more transformers and one of a plurality of electrolysis stacks of the electrolysis device; and a controller configured to control the converter unit and/or the rectifier unit to adjust a direct current supplied to at least one of the plurality of electrolysis stacks.

According to another embodiment of the disclosure, a method for controlling a power supply system to power an electrolysis device is provided. The power supply system includes a converter unit, a transformer unit coupled with the converter unit, and a rectifier unit comprising a plurality of rectifiers. Each rectifier is coupled between the transformer unit and one of a plurality of electrolysis stacks of the electrolysis device. The method includes the step of controlling the converter unit and/or the rectifier unit to adjust a direct current supplied to at least one of the plurality of electrolysis stacks.

According to yet another embodiment of the disclosure, a controller for controlling a power supply system to power to an electrolysis device is provided. The controller includes one or more processors configured to execute the method described above.

### BRIEF DESCRIPTION OF THE DRAWINGS

The disclosed aspects will hereinafter be described in connection with the appended drawings that are provided to illustrate but not to limit the scope of the disclosure.

FIG. 1 is a block diagram of a power supply system for powering an electrolysis device according to an embodiment of the disclosure.

FIGS. 2-12B show examples of the power supply system in FIG. 1.

FIG. 13 is a flow chart of a method for controlling the power supply system to power an electrolysis device according to an embodiment of the disclosure.

FIG. 14 is a flow chart of a method for controlling the power supply system to power an electrolysis device according to another embodiment of the disclosure.

FIG. 15 is a flow chart of a method for controlling the power supply system to power an electrolysis device according to yet another embodiment of the disclosure.

FIGS. 16 and 17 are schematic diagrams showing the principle of examples of the method in FIG. 15.

FIG. 18 is a flow chart of a method for controlling the power supply system to power an electrolysis device according to still yet another embodiment of the disclosure.

FIG. 19 is flow chart of a method for controlling the power supply system to power an electrolysis device according to still yet another embodiment of the disclosure.

### DETAILED DESCRIPTION

### Overview

An aspect of the disclosure provides a power supply system for powering an electrolysis device. The power supply system includes a front-end converter, a transformer (e.g., MFT: medium frequency transformer), a back-end rectifier, a controller, and a switch. At least one of the front-end converter and the back-end rectifier includes a controllable power electronic device, such that the controller can control at least one of the front-end converter and the back-end rectifier to regulate the a direct current supplied to the electrolysis device. In this case, the power supply to the electrolysis device can be dynamically adjusted according to the state of the electrolysis device.

In an example, the electrolysis device includes a plurality of electrolysis stacks. The power supply system can simultaneously power the plurality of electrolysis stacks and independently control the power supply to each electrolysis stack. In this way, it is beneficial to balance operating states of the plurality of electrolysis stacks and to slow down the aging speed of severely aged electrolysis stacks. For example, the controller independently controls the power supply to each of the plurality of electrolysis stacks such that the operating states of these electrolysis stacks can be balanced, and that the total hydrogen production efficiency of these electrolysis stacks can be maximized, and that the service life of severely aged electrolysis stacks can be increased to reduce maintenance costs.

In an example, if a single electrolysis stack is faulty, the pow supply to the single faulty electrolysis stack can be quickly cut off without affecting the work of other electrolysis stacks. In addition, compared with using a 50 Hz transformer in prior art solutions, according to the provided solution of using an MFT with a frequency of about 400 Hz, the timing for operating a power electronic device to cut off a load current of a faulty electrolysis stack will come more quickly. Therefore, the provided solution has the advantages of high safety and fast protection speed.

### EXAMPLE SYSTEMS

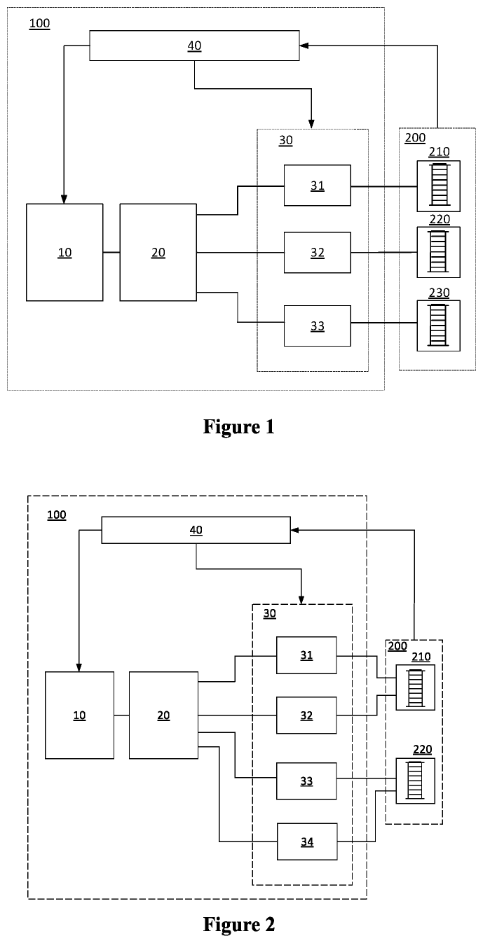

FIG. 1 shows a power supply system 100 according to an embodiment of the present disclosure. The power supply system 100 can control the power supply to the electrolysis device 200 by adjusting a supplied direct current to the electrolysis device 200.

Referring to FIG. 1, the power supply system 100 includes a converter unit 10, a transformer unit 20, a rectifier unit 30 and a controller 40.

The converter unit 10 includes one or more converters. Each converter can be implemented as an AC/AC converter coupled between an AC grid (not shown) and the transformer unit 20. Each converter can also be implemented as a DC/AC converter coupled between a DC grid (not shown) and the transformer unit 20. In an example where the converter unit 10 includes two or more converters, these converters can be connected in parallel or cascaded according to specific application scenarios.

The transformer unit 20 includes one or more transformers. The transformer unit 20 is coupled between the converter unit 10 and the rectifier unit 30. In an example, each transformer can be implemented as an MFT (medium frequency transformer). In an example, the operating frequency range of each transformer is 100Hz-30 kHz, preferably 300Hz-10 kHz, more preferably 400Hz-800Hz. Compared with a commonly used 50 Hz transformer, using such transformers (e.g., MFTs or transformers having the above-mentioned operating frequency range) in the power supply system 100 has the advantage of small size, which facilitates modular design. Moreover, the rectifier unit 30 operating at the above-mentioned frequency range will produce less DC ripple, and thus less design requirements of a filter reactor for the power supply system 100 are required. In addition, compared with operating at 50Hz, operating in the above-mentioned frequency range has the advantages of faster protection and control speed.

The rectifier unit 30 includes a plurality of rectifiers 31~33. Each rectifier is coupled between the converter unit 20 and the electrolysis device 200. Each of the plurality of rectifiers can be implemented as a controllable AC/DC rectifier. For example, each of the plurality of rectifiers can be implemented as a thyristor. Each of the plurality of rectifiers can also be implemented to include a diode and a controllable DC/DC converted connected in series with the diode. Each of the plurality of rectifiers can also be implemented as a non-controllable AC/DC rectifier.

It is noted that FIG. 1 illustrates the rectifier unit 30 includes 3 rectifiers; however, according to examples of the present disclosure, the rectifier unit 30 can be implemented to include a greater or lesser number of rectifiers.

It is noted that, as shown in FIG. 1, in the power supply system 100, the converter unit 10 is arranged at the front end, and the rectifier unit 30 is arranged at the back end. Therefore, a converter of the converter unit 10 can be called as a front-end converter, and a rectifier of the rectifier unit 30 can be called as a back-end rectifier.

In examples of the present disclosure, the electrolysis device 200 refers to a hydrogen electrolysis device. For example, the electrolysis device uses electrical energy to split water into hydrogen and oxygen during electrolysis. Through such an electrolysis process, the electrolysis device produces hydrogen gas. The electrolysis device 200 is, for example, a PEM (Proton Exchange Membrane) electrolysis device. The electrolysis device 200 can include a plurality of electrolysis stacks each having one or more electrolysis cells. If a single electrolysis stack is faulty, this faulty electrolysis stack can be quickly disconnected from the power supply system 100 by operating a front-end converter and/or a back-end rectifier to cut off the load current in a corresponding branch circuit. Then, the branch switch connected in the corresponding branch circuit is switched off in the case of no load current, so that the faulty electrolysis stack can be replaced or maintained.

There are multiple ways of coupling the power supply system 100 with the electrolysis device 200. In an example, each rectifier of the rectifier unit 30 is coupled to one of the plurality of electrolysis stacks and powers said one electrolysis stack. For example, referring to FIG. 1, the electrolysis device 200 includes three electrolysis stacks 210-230. The rectifier 31 of the rectifier unit 30 is coupled to the electrolysis stack 210 and powers the electrolysis stack 210. The rectifier 32 rectifier unit 30 is coupled to the electrolysis stack 220 and powers the electrolysis stack 220. The rectifier 33 rectifier unit 30 is coupled to the electrolysis stack 230 and powers the electrolysis stack 230. In another example, two or more rectifiers of the rectifier unit 30 are coupled to one of the plurality of electrolysis stacks and powers said one electrolysis stack. For example, referring to FIG. 2, the electrolysis device 200 includes two electrolysis stacks 210-220. Both rectifiers 31 and 32 of the rectifier unit 30 are coupled to the electrolysis stack 210 and power the electrolysis stack 210 together. Both rectifiers 33 and 34 are coupled to the electrolysis stack 220 and powers the electrolysis stack 220 together.

The controller 40 can be communicatively connected with the converter unit 10 and the rectifier unit 30. The controller 40 can also be communicatively connected with the electrolysis device 200. In an example, the controller 40 receives information on the state (i.e., state information) of the electrolysis device 200, and controls the converter unit 10 and/or the rectifier unit 30 based on the received information to regulate a direct current supplied to the electrolysis device 200 based on the state of the electrolysis device 200. In this wat, the power supply to the electrolysis device 200 can be dynamically adjusted based on the state of the electrolysis device 200.

In an example, the state of the electrolysis device 200 can be detected by one or more sensors (not shown) associated with the electrolysis device 200 and/or calculated based on detections from the sensors. The state information includes, for example, one or more of the following parameters: a hydrogen production rate of each electrolysis stack, a total hydrogen production rate of the plurality of electrolysis stacks, a current of each electrolysis stack, a voltage of each electrolysis stack, an operating efficiency of each electrolysis stack, a state of health (SOH) of each electrolysis stack, and an operating state of each electrolysis stack (e.g., a no-load state, a light-load state, a full-load state or an overload state).

The controller 40 may be implemented in a distributed control system. For example, the distributed control system includes a plurality of control nodes communicatively connected to each other, and the controller 40 is disposed in one of the plurality of control nodes. These control nodes can include a local controller at the converter unit 10, a local controller at the rectifier unit 30 and a local controller at the electrolysis device 200.

The controller 40 can also be implemented in a centralized control system. For example, the centralized control system includes a high-level controller (e.g., a central controller) and a plurality of low-level controllers in communication with the high-level controller. The controller 40 is provided in the high-level controller. The plurality of low-level controllers can include a local controller at the converter unit 10, a local controller at the rectifier unit 30 and a local controller at the electrolysis device 200.

The controller 40 can be implemented by means of hardware or software or a combination of hardware and software, including code stored in a non-transitory computer-readable medium such as a memory and implemented as instructions executed by a processor. Regarding the part implemented by means of hardware, it may be implemented in an application-specific integrated circuit (ASIC), a digital signal processor (DSP), a data signal processing device (DSPD), a programmable logic device (PLD), a field programmable gate array (FPGA), a processor, a controller, a microcontroller, a microprocessor, an electronic unit, or a combination thereof. The part implemented by software may include a microcode, a program code or code segments. The software may be stored in a machine-readable storage medium, such as a memory.

In an example, the controller 40 can include a memory and a processor. The instructions are stored in the memory. The instructions, when executed by the processor, cause the processor to execute control methods according to examples of the disclosure.

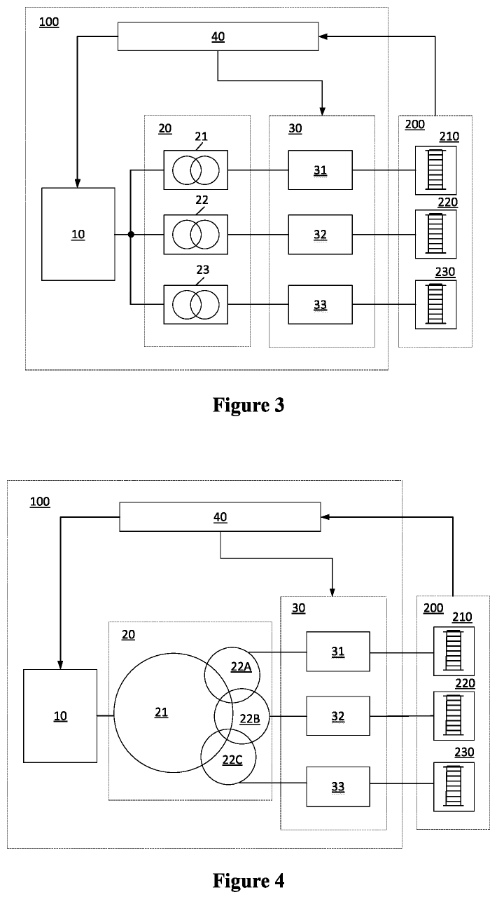

Examples of the power supply system 100 will be introduced with reference to FIG. 3~12B.

FIG. 3 illustrates an example of the power supply system 100. In this example, the transformer unit 20 includes a plurality of transformers. As shown in FIG. 3, the transformer unit 20 includes three transformers 21~23. Each transformer is coupled between the converter unit 10 and a corresponding one of the plurality of rectifiers of the rectifier unit 30. For example, the transformer 21 is coupled between the converter unit 10 and the rectifier 31, the transformer 22 is coupled between the converter unit 10 and the rectifier 32, and the transformer 23 is coupled between the converter unit 10 and the rectifier 33.

FIG. 4 shows another example of the power supply system 100. In this example, the transformer unit 20 includes one transformer having a primary winding 21 and a plurality of secondary windings 22A~22C. The primary winding 21 is coupled to converter unit 10. Each secondary winding is coupled to one of a plurality of rectifiers of the rectifier units 30. For example, the secondary winding 22A is coupled to the rectifier 31, the secondary winding 22B is coupled to the rectifier 32, and the secondary winding 22C is coupled to the rectifier 33.

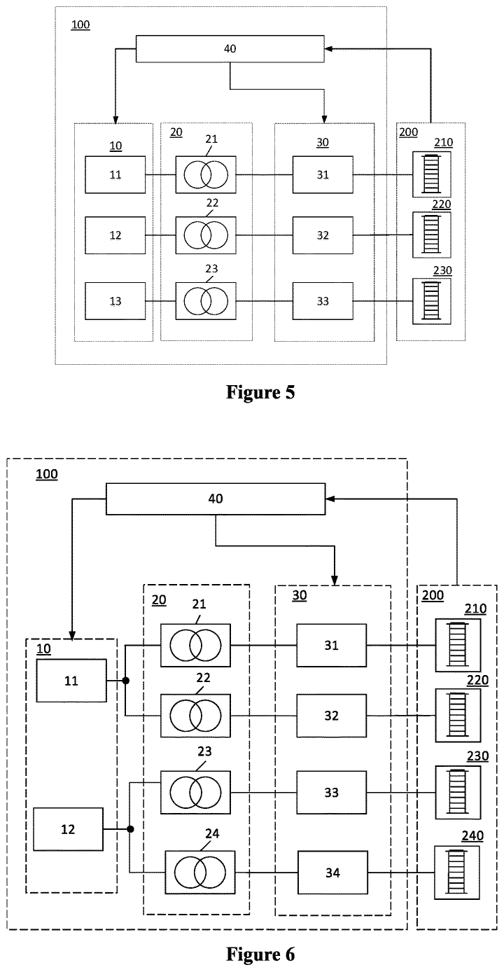

FIG. 5 shows yet another example of the power supply system 100. In this example, the converter unit 10 includes a plurality of converters 11~13, and the transformer unit 20 includes a plurality of transformers 21~23. Each transformer is connected to one of the plurality of converters. As shown in FIG. 5, the converter 11 is coupled to the transformer 21 and the transformer 21 is coupled between the converter 11 and the rectifier 31. The converter 12 is coupled to the transformer 22 and the transformer 22 is coupled between the converter 12 and the rectifier 32. The converter 13 is coupled to the transformer 23 and the transformer 23 is coupled between the converter 13 and the rectifier 33.

FIG. 6 shows yet another example of the power supply system 100. In this example, the converter unit 10 includes a plurality of converters and each converter is coupled with two or more transformers. As shown in FIG. 6, the converter unit 10 includes two converters 11 and 12, and the transformer unit 20 includes four transformers 21-24. The converter 11 is coupled to both the transformer 21 and the transformer 22. The converter 12 is coupled to both the transformer 23 and the transformer 24.

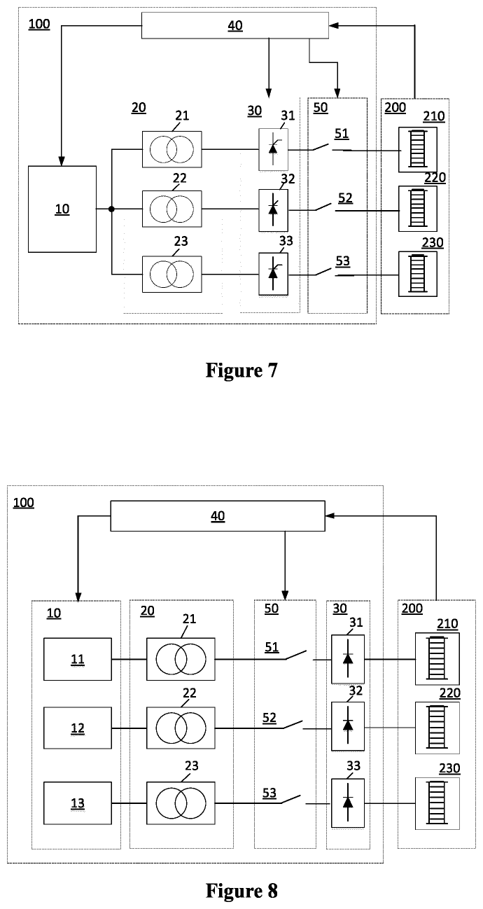

FIG. 7 shows yet another example of the power supply system 100. In this example, the power supply system 100 further includes a switch unit 50 coupled between the rectifier unit 30 and the electrolysis device 200, which includes a plurality of switches 51-53. As shown in FIG. 7, the switch unit 50 includes a plurality of switches 51-53. Each switch is coupled between one of a plurality of rectifiers and one of a plurality of electrolysis stacks. For example, the switch 51 is coupled between the rectifier 31 and the electrolysis stack 210, the switch 52 is coupled between the rectifier 32 and the electrolysis stack 220, and the switch 53 is coupled between the rectifier 33 and the electrolysis stack 230.

Each switch can be implemented as a no load switch (e.g., an off load switch disconnector that must open and close the circuit when load is off) and turned on or off manually. Each switch can also be implemented as an on-load switch (e.g., an on load switch disconnector that can open and close the circuit on load) turned on or off under the control of the controller 4.

In an example, the switch unit 50 is coupled between the rectifier unit 30 and the electrolysis device 200. This example is applied in particular to the case where each rectifier is implemented as a controllable rectifier. In another example, the switch unit 50 is coupled between the transformer unit 20 and the rectifier unit 30. This example is applied in particular to the case where each rectifier is implemented as an uncontrollable rectifier.

FIG. 8 shows yet another example of the power supply system 100. In this example, the switch unit 50 is coupled between the transformer unit 20 and the rectifier unit 30. The transformer unit 50 includes a plurality of switches. In this example, each rectifier of the rectifier unit 30 can be implemented as an uncontrollable AC/DC rectifier such as a diode.

As shown in FIG. 8, the switch unit 50 includes a plurality of switches 51-53. Each switch is coupled between one of a plurality of transformers and one of a plurality of rectifiers. For example, the switch 51 is coupled between the transformer 21 and the rectifier 31, the switch 52 is coupled between the transformer 22 and the rectifier 32, and the switch 53 is coupled between the transformer 23 and the rectifier 33.

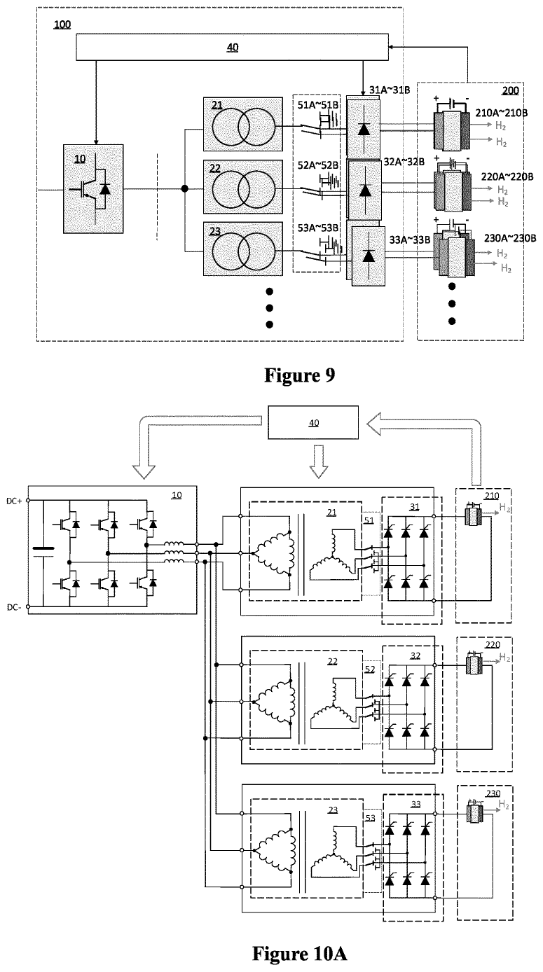

FIG. 9 is a modified example of the power supply system 100 in FIG. 8. In this modified example, the secondary side of each transformer is coupled to a plurality of diodes and each diode is coupled to one of a plurality of electrolysis stacks. For example, the secondary side of the transformer 21 is coupled to two diodes 31A and 31B and each diode of the two diodes is coupled to one of two electrolysis stacks 210A and 210B.

Moreover, in the exemplary power supply system in FIG. 9, a branch switch is provided in each of a plurality of branch circuits between each transformer and a plurality of diodes. For example, each of branch switches 51A and 51B is provided in one of branch circuits between the transformer 21 and diodes 31A and 31B. In this way, if a single electrolysis stack is faulty, the load current in the branch circuit of the faulty electrolysis stack can be cut off by operating a corresponding branch switch, so as to replace or maintain the faulty electrolysis stack without affecting the work of other electrolysis stacks.

Referring to FIG. 9, the secondary side of the transformer 21 is coupled with a plurality of diodes 31A and 31B. Branch switches 51A and 51B are respectively provided in each of a plurality of branch circuits between the secondary side of the transformer 21 and the plurality of diodes 31A and 31B. Each of the diodes 31A and 31B is coupled to one of the electrolysis stacks 210A and 210B. Similarly, the secondary side of the transformer 22 is coupled with a plurality of diodes 32A and 32B. Branch switches 52A and 52B are respectively provided in each of a plurality of branch circuits between the secondary side of the transformer 22 and the plurality of diodes 32A and 32B. Each of the diodes 32A and 32B is coupled to one of the electrolysis stacks 220A and 220B. The secondary side of the transformer 23 is coupled with a plurality of diodes 33A and 33B. Branch switches 53A and 53B are respectively provided in each of a plurality of branch circuits between the secondary side of the transformer 23 and the plurality of diodes 33A and 33B. Each of the diodes 33A and 33B is coupled to one of the electrolysis stacks 230A and 230B. Based on such a topology, the load current in a branch circuit can be cut off by operating a corresponding branch switch. For example, the load current in the branch circuit between the transformer 21 and the diode 31A can be cut off by operating the branch switch 51A.

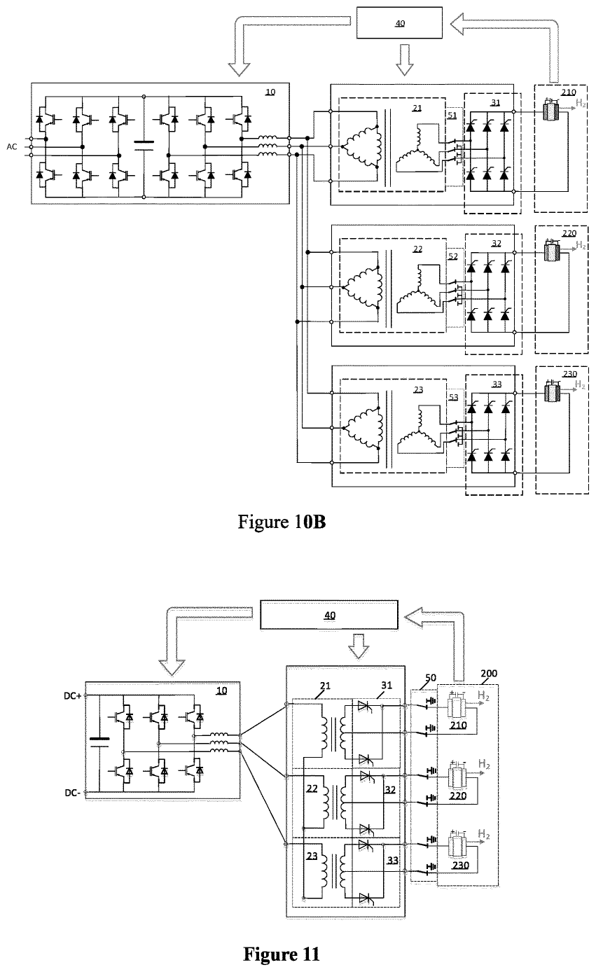

FIGS. 10A and 10B show other examples of the power supply system 100. FIG. 10A shows an example where the front-end converter is implemented as a DC/AC converter. FIG. 10B shows an example where the front-end converter is implemented as an AC/AC converter. In examples of FIGS. 10A and 10B, for each of a plurality of transformers 21-23, a phase current output from the transformer can be cut off by operating a corresponding branch switch. For example, as shown in FIG. 10A, three branch switches are disposed between the transformer 21 and the rectifier 31. Each of the three branch switches is disposed in a branch circuit between one of the three-phase outputs of the transformer 21 and one phase bridge arm of the rectifier 31. In the examples of FIGS. 10A and 10B, the load current can be cut off by detecting zero crossing of the phase current and cutting off the phase current at the zero crossing.

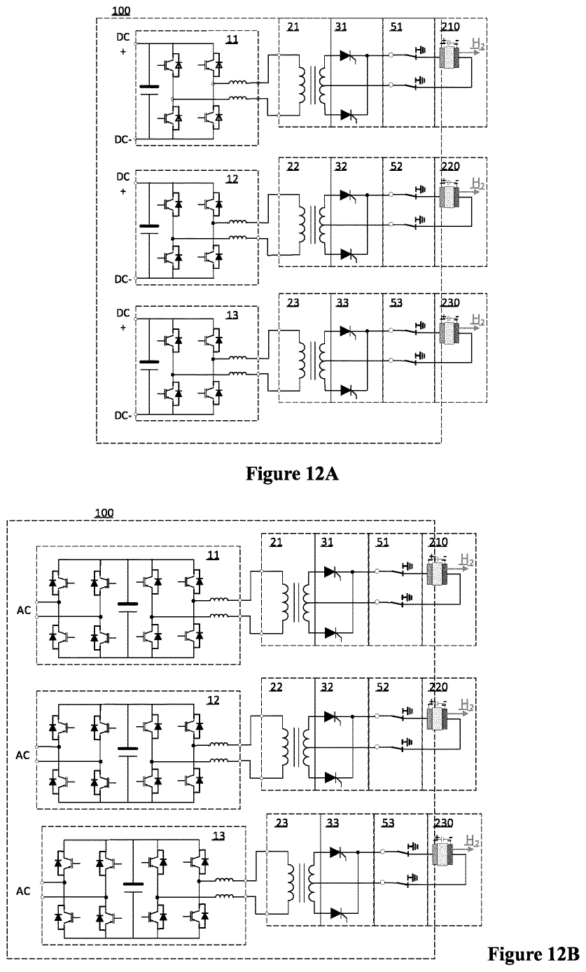

FIGS. 11, 12A and 12B are examples of a single-phase connection of the power supply system 100. As shown in FIG. 11, each of the three-phase outputs of the front-end converter 10 is coupled to the primary side of one of the plurality of transformers 21~23. Moreover, for each electrolysis stack, one no-load switch is coupled to the positive end of the electrolysis stack and another no-load switch is coupled to the negative end of the electrolysis stack. FIG. 12A shows an example where each of the front-end converter 11~13 is implemented as a DC/AC converter. FIG. 12B shows an example where each of the front-end converters 11~13 is implemented as an AC/AC converter. As shown in FIGS. 12A and 12B, the output of each front-end converter is coupled to the primary side of one of the transformer 21~23. Moreover, for each electrolysis stack, one no-load switch is coupled to the positive end of the electrolysis stack and another no-load switch is coupled to the negative end of the electrolysis stack.

According to examples of the disclosure, in addition to the above-mentioned no-load switch, each of the branch switches can be implemented as other types of switches, such as an on-load switch or a circuit breaker. The branch switches are used as protection means for cutting off the working current or short-circuit current.

### EXAMPLE METHODS

Further to example systems described above, example methods are now described. Such methods can be performed by the controller 40. It should be understood that the operations involved in the following methods need not be performed in the precise order described. Rather, various operations may be performed in a different order or simultaneously, and operations may be added or omitted.

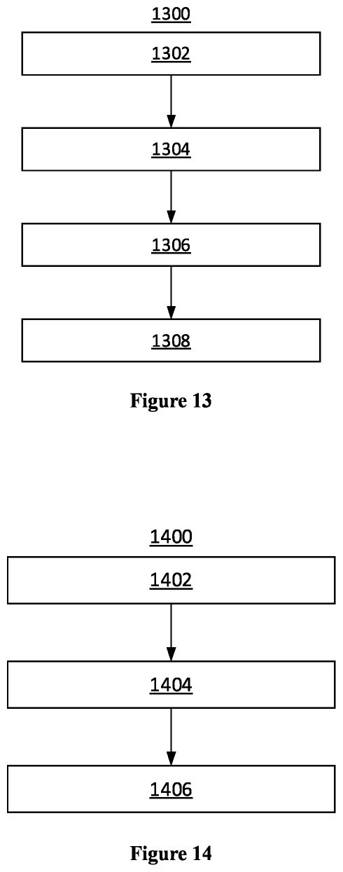

FIG. 13 is a flow chart of a method 1300 for controlling the power supply system 100 to power the electrolysis device 200 according to an embodiment of the present disclosure.

As shown in FIG. 13, at block 1302, information on the state of each of the plurality of electrolysis stacks is obtained. The information includes an operating efficiency of each electrolysis stack.

The operating efficiency of an electrolysis stack can be determined based on a current and a voltage of the electrolysis stack. Here, the current of the electrolysis stack corresponds to (e.g., is proportional to) the hydrogen production rate of the electrolysis stack. The voltage of the electrolysis stack is related to the internal resistance and the current of the electrolysis. For an electrolysis stack, when the hydrogen production rate remains constant, the current of the electrolysis stack would remain unchanged. If the internal resistance of the electrolysis stack is becoming higher, the voltage of the electrolysis stack would also become higher, which means greater power consumption would be required to produce the same amount of hydrogen. In this case, the operating efficiency of the electrolysis stack is becoming lower. In another aspect, for an electrolysis stack, when the hydrogen production rate of the electrolysis stack remains constant, the current of the electrolysis stack would remain unchanged. If the internal resistance of the electrolysis stack is becoming smaller, the voltage of the electrolysis stack would also become smaller, which means less power consumption would be required to produce the same amount of hydrogen. In this case, the operating efficiency of the electrolysis stack is becoming higher.

The operating efficiency of an electrolysis stack can be represented by a percentage, and the larger the percentage, the higher the operating efficiency. The operating efficiency of an electrolysis stack can also be represented by a value between 0 and 1, and the closer the value is to 1, the higher the operating efficiency. The operating efficiency of an electrolysis stack can also be represented by two or more levels indicating different levels of the operating efficiency.

The operating efficiency of each electrolysis stack can be calculated based on the current and voltage of the electrolysis stack. The calculation can be performed by a local controller at the electrolysis device 200 or by the controller 40.

At block 1304, the operating efficiency of each electrolysis stack is compared to an operating efficiency threshold.

Here, the operating efficiency threshold is used for judging whether the operating state of an electrolysis stack needs to be adjusted. In an example, the operating efficiency threshold is a predetermined fixed value. In this example, the operating efficiency threshold can be predetermined based on specific application scenarios. In another example, the operating efficiency threshold has a predetermined initial value. The controller 40 takes the initial value as a starting point and adjusts the operating efficiency threshold based on an operating efficiency (i.e., an actual operating efficiency which might change dynamically) of each electrolysis stack, so that the operating efficiency threshold is always between the best operating efficiency and the worst efficiency of operating efficiencies of all the electrolysis stacks.

At block 1306, for an electrolysis stacks operating at an operating efficiency less than the operating efficiency threshold, the controller 40 controls the converter unit 10 and/or the rectifier unit 30 to reduce the direct current supplied to the electrolysis stack. On the other hand, for an electrolysis stack operating at an operating efficiency greater than the operating efficiency threshold, the controller 40 controls the converter unit 10 and/or the rectifier unit 30 to reduce the direct current supplied to the electrolysis stack. In addition, for an electrolysis stack operating at an operating efficiency that is exactly equal to the operating efficiency threshold, the direct current supplied to the electrolysis stack is unchanged. In this way, the electrolysis stack with higher operating efficiency would be operated to produce more hydrogen, while the electrolysis stack with lower operating efficiency would be operated to produce less hydrogen, so as to achieve the purpose of improving the overall hydrogen production efficiency of all the electrolysis stacks.

In an example, the controller 40 reduces the direct current provided to the electrolysis stack operating at an operating efficiency less than the operating efficiency threshold with a predetermined decreasing slope. The controller 40 increases the direct current provided to the electrolysis stack operating at an operating efficiency greater than the operating efficiency threshold with a predetermined increasing slope.

In this example, the controller 40 can dynamically adjust the decreasing slope or the increasing slope. Here, the decreasing slope refers to a speed at which the supplied direct current decreases. Adjusting the decreasing slope means adjusting the speed at which the supplied direct current decreases. The increasing slope refers to a speed at which the supplied direct current increases. Adjusting the increasing slope means adjusting the speed at which the supplied direct current increases. For example, as the difference between the operating efficiency (i.e., the actual operating efficiency) and the operating efficiency threshold increases, the controller 40 increases the absolute value of the decreasing slope or the increasing slope. On the other hand, as the difference between the operating efficiency (i.e., the actual operating efficiency) and the operating efficiency threshold decreases, the controller 40 decreases the absolute value of the decreasing slope or the increasing slope. This is advantageous because as the difference between the actual operating efficiency and the operating efficiency threshold increases, a greater amount of adjustment to the supplied direct current will be required. In this case, the greater amount of adjustment can be completed quickly by making the increasing slope or the decreasing slope steeper. Also, as the difference between the actual operating efficiency and the operating efficiency threshold becomes smaller, a less amount of adjustment to the supplied direct current will be required. In this case, the less amount of adjustment can be achieved precisely by making the increasing slope or the decreasing slope smaller.

In the following, examples of the controlling of the converter unit and/or the rectifier unit are introduced in combination with the above described topologies of the power supply system 100. In general, examples of the controlling of the converter unit and/or the rectifier unit include: 1) controlling only the front-end converter; 2) controlling only the back-end rectifier; and 3) controlling both the front-end converter and the back-end rectifier.

In an example, referring to FIG. 1, in the power supply system 100, each back-end rectifier is implemented as a controllable rectifier, for example, a thyristor or a diode and a DC/DC converter connected in series with the diode. In this way, each back-end rectifier can be controlled to regulate the direct current supplied to each electrolysis stack. For example, in the case that a supplied direct current to the electrolysis stack 210 needs to be reduced and the rectifier 31 is implemented as a thyristor, the controller 40 controls the thyristor to increase the firing angle of the thyristor. In the case that the rectifier 31 is implemented as a diode and a DC/DC converter connected in series with the diode, the controller 40 controls the duty cycle power electronic switching devices (e.g., IGBT, MOSFET) of the DC/DC converter to reduce the supplied current to the electrolysis stack 210.

In another example, referring to FIG. 8, in the power supply system 100, the converter unit 10 includes a plurality of controllable converters and each back-end rectifier is implemented as an uncontrollable diode. In this case, the controller 40 independently controls each of the plurality of controllable converters to regulate the supplied current to each electrolysis stack. For example, when the direct current supplied to the electrolysis stack 210 needs to be reduced, the controller 40 controls the converter 11 to reduce the direct current supplied to the electrolysis stack 210.

In yet another example, referring to FIG. 3, in the power supply system 100, the converter unit 10 includes one converter, and each of the plurality of rectifier is implemented as a controllable rectifier, such as a thyristor, a diode and a DC/DC converter connected in serious with the diode, or a thyristor and a DC/DC converter connected in serious with the thyristor. In this example, the controller 40 controls the front-end converter to achieve an overall regulation and independently controls each back-end rectifier to achieve fine-tuning of the direct current supplied to each electrolysis stack. That is, in this example, the controller 40 can control both the front-end converter and the back-end rectifier to adjust the direct current to each electrolysis stack. For example, in the case that the direct current supplied to the electrolysis device 200 needs to be increased and the direct current supplied to the electrolysis stack 210 needs to be slightly reduced, the controller 40 first controls the converter 10 to increase the direct current in each branch circuit, and then controls the rectifier 31 to reduce the direct current supplied to the electrolysis stack 210. For example, in a case where the rectifier 31 is implemented as a thyristor, the controller 40 controls the thyristor 31 to increase the firing angle of the thyristor. In a case where the rectifier 31 is implemented as a diode and a DC/DC converter, the controller 40 control the DC/DC converter to adjust the duty cycle of power electronic switching devices (e.g., IGBT, MOSFET, etc.) such that the direct current supplied to the electrolysis stack 210 is reduced.

It is noted that the adjustment by the back-end rectifier should be fine tuning. For example, the adjustment to the firing angle of a thyristor should be within 10°.

In yet another example, referring to FIG. 5, in the power supply system 100, the converter unit 10 includes a plurality of converters and each back-end rectifier is implemented as a controllable rectifier (e.g., a thyristor or a diode and a DC/DC converter connected in serious with the diode.) In this example, the controller 40 can control both the front-end converter and the back-end rectifier to adjust the supplied direct current. For example, in the case that the direct current supplied to the electrolysis stack 210 needs to be reduced, the controller 40 first controls the converter 11 to reduce the supplied current to the electrolysis stack 210, and then controls the rectifier 31 to perform fine tuning. In this example, most (e.g., 90%~100%) of the total adjustment amount of the supplied current can be realized by the front-end converter, and only a partial (e.g., 0~10%) of the total adjustment amount of the supplied current can be realized by the back-end rectifier.

It is noted that, in this example, the controller 40 can also only control the front-end converter or only control the back-end rectifier to adjust the supplied direct current. For this situation, reference can be made to the above-mentioned examples, and details are not repeated here.

At block 1308, the controller 40 monitors the situation of hydrogen production of each electrolysis stack and controls the supplied current to one or more electrolysis stack such that the total hydrogen production efficiency of all the electrolysis stacks is maximized. For example, the controller 40 dynamically adjusts the direct current supplied to each electrolysis stack based on the situation of hydrogen production of each electrolysis stack until the total hydrogen production efficiency of all the electrolysis stacks is maximized.

Here, the total hydrogen production efficiency being maximized refers to one of the following two cases: 1) the total hydrogen production of all the electrolysis stacks reaches a target total hydrogen production and the electric energy consumed by all the electrolysis stacks is minimum; 2) the electric energy consumed by all the electrolysis stacks is constant and the total hydrogen production of the electrolysis stacks is maximum.

FIG. 14 is a flow chart of a method 1400 for controlling the power supply system 100 to power the electrolysis device 200 according to another embodiment of the present disclosure.

As shown in FIG. 14, at block 1402, information on a state of each electrolysis stack is obtained. The obtained information includes an aging degree of each electrolysis stack.

In an example, the obtained information includes state parameters of each electrolysis stack (e.g., a current and voltage of each electrolysis stack) and the aging degree of each electrolysis stack can be calculated based on the state parameters. For example, the aging degree of each electrolysis stack can be calculated according to the current and voltage of each electrolysis stack. The aging degree of each electrolysis stack can also be calculated according to the obtained state parameters and rated parameters. For example, an aging degree of an electrolysis stack is calculated based on a ratio of the current of the electrolysis stack to the rated current of the electrolysis stack. It is noted that the present disclosure does not limit how to calculate the aging degree. The calculation of the ageing degree can be performed either in a local controller at the electrolysis device 200 or in the controller 40.

The aging degree of an electrolysis stack can be quantitatively expressed by one of: 1) a percentage and 2) a value between 0 and 1.

At block 1404, the controller 40 controls the converter unit 10 and/or the rectifier unit 30 to reduce the direct current supplied to the electrolysis stack having an aging degree greater than an aging degree threshold, so as to slow down the aging speed of the electrolysis stack. In this way, the service life of seriously aged electrolysis stacks can be extended, thereby reducing the cost for replacement or maintenance. Moreover, the aging speed of each electrolysis stack can be made to be all most the same, and thus the overall service life of all the electrolysis stacks can be comprehensively improved.

Here, the aging degree threshold is used for judging, from aging point of view, whether the supplied current to an electrolysis stack needs to be adjusted.

In an example, the aging degree threshold is a predetermined fixed value. In this example, the aging degree threshold can be predetermined based on specific application scenarios and the overall aging speed of all the electrolysis stacks expected by a user. In another example, the aging degree threshold has a predetermined initial value. The controller 40 takes the initial value as a starting point and dynamically adjusts the aging degree threshold, so that the aging degree threshold is always between an aging degree indicative of most seriously aging and an aging degree indicative of slightest aging among the plurality of electrolysis stacks.

It is noted that reference of examples of controlling the converter unit and/or the rectifier unit in block 1404 could be made to relevant descriptions above, and details are not repeated here.

At block 1406, the controller 40 calculates a service life of each electrolysis stack in real time and controls the converter unit and/or the rectifier unit such that the service life of each electrolysis stack is almost the same. For example, the controller 40 predicts a service life of each electrolysis stack by using a trained machine learning model which is capable of predicting the service life of an electrolysis stack based on model inputs such as a current, voltage and temperature of the electrolysis stack.

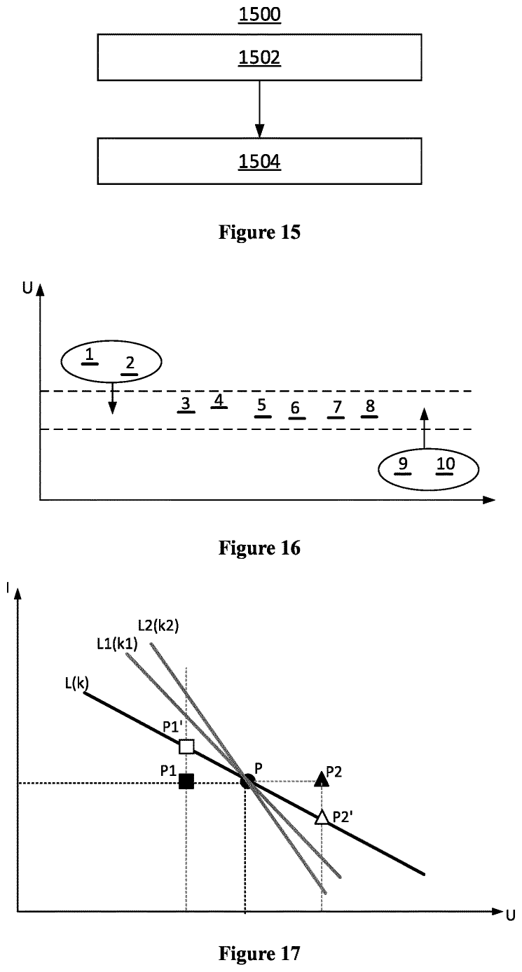

FIG. 15 is a flow chart of a method 1500 for controlling the power supply system 100 to power the electrolysis device 200 according to yet another embodiment of the present disclosure.

As shown in FIG. 15, at block 1502, the controller 40 obtains information on states of two or more electrolysis stacks. The obtained information for example includes the current and voltage that can indicate the state of each of the two or more electrolysis stacks. The current and voltage can be obtained by measuring at two or more electrolysis stacks. The current and voltage can also be obtained by measuring at corresponding rectifiers.

At block 1504, the controller 40 controls the converter unit and/or the rectifier unit to adjust direct currents supplied to the two or more electrolysis stacks based on the obtained information to balance the states of the two or more electrolysis stacks.

In an example, balancing the states of the two or more electrolysis stacks includes: making electrolysis stacks with larger internal resistance and higher power consumption (such electrolysis stacks might also have lower operating efficiency and poor health, and are seriously aged) produce less hydrogen, and making the electrolysis stacks with smaller internal resistance and lower power consumption (such electrolysis stacks might also have higher operating efficiency and good health, and are lightly aged,) produce more hydrogen. Such balancing can bring beneficial effects in the following three aspects: 1) improving the overall operating efficiency of all the electrolysis stacks; 2) slowing down the aging speed of seriously aged electrolysis stacks; and 3) extending the overall life of all the electrolysis stacks.

The above mentioned balancing solution is especially applicable to the following situation: each of the two or more electrolysis stacks has the same hydrogen production (i.e., each of the two or more electrolysis stacks has the same current), one or more electrolysis stacks have relatively high internal resistance and thus have relatively high voltage (e.g., higher than the upper limit of a predetermined voltage range), and one or more electrolysis stacks have relatively low internal resistance and thus have relatively low voltage (e.g., lower than the lower limit of the predetermined voltage range). In this situation, the controller 40 controls the converter unit and/or the rectifier unit to reduce the direct current supplied to the one or more electrolysis stacks having relatively high voltage and increase the direct current supplied to the one or more electrolysis stacks having relatively lower voltage.

Examples of the control under this situation will be introduced below with reference to FIGS. 16 and 17. It is noted that the numerical values in the examples described below are exemplary, and the present disclosure is not limited thereto.

In an example, referring to FIG. 16, the electrolysis device 200 includes 10 electrolysis stacks 1-10, and the current of each electrolysis stack is the same, for example, 5000A. As shown in FIG. 16, six electrolysis stacks 3-8 of the electrolysis stacks 1-10 have voltages within a predetermined voltage range (as shown in FIG. 16, the dotted lines show the predetermined voltage range, and the voltages of the electrolysis stacks 3~8 are all within the predetermined voltage range shown by the dotted line). Two electrolysis stacks 1~2 of the electrolysis stacks 1-10 have voltages higher than the upper limit of the predetermined voltage range. Two electrolysis stacks 9-10 of the electrolysis stacks 1-10 have voltages lower than the lower limit of the predetermined voltage range. In this case, the controller 40 controls the converter unit and/or the rectifier unit associated with the electrolysis stacks 1~2 to reduce supplied currents to the electrolysis stacks 1~2, so that the voltages of the electrolysis stacks 1~2 are reduced to within the predetermined voltage range (see the downward arrow in FIG. 16), and control the converter unit and/or rectifier unit associated with the electrolysis stacks 9~10 to increase the supplied currents to the electrolysis stacks 9~10, so that the voltages of the electrolysis stacks 9~10 are increased to within the predetermined voltage range (see the upward arrow in FIG. 16).

It can be understood that the example of FIG. 16 can also be realized by using power of each electrolysis stack. For example, the control of the converter unit and/or the rectifier unit can also be realized by replacing the voltage U in FIG. 16 with the power P.

In another example, referring to FIG. 17, the balancing solution is implemented by means of a reference curve. The reference curve can be a current-voltage reference curve, a current-operating efficiency reference curve, a current-power reference curve, a current-aging degree reference curve or a current-aging speed reference curve. In the below, an example of using the current-voltage curve (I-U curve) is described with reference to FIG. 17.

As shown in FIG. 17, the ordinate represents current I of an electrolysis stack, and the abscissa represents voltage U of the electrolysis stack. The curve L(k) represents the reference U-I curve of the electrolysis stack and has a slope of k. Point P (see the solid circle point in FIG. 17) on the curve L(k) represents a reference operating point/rated working point of the electrolysis stack. Point P1 (see the solid square point in FIG. 17) represents an actual operating point of the electrolysis stack. Compared to the reference operating point P, point P1 represents an operating state of with the same current but a lower voltage. That is to say, the electrolysis stack is operating with higher efficiency than that of the reference operating state. In this case, the controller 40 controls the converter unit 10 and/or the rectifier unit 30 to increase the direct current supplied to the electrolysis stack so that the actual operating point of the electrolysis stack moves from point P1 up to point P1′ (see the hollow square point in FIG. 17) on the curve L(k). Point P2 (see the solid triangle point in FIG. 17) on the curve L(k) represents another actual operating point of the electrolysis stack. Compared to the reference operating point P, point P1 represents an operating state of with the same current but a higher voltage. That is to say, the electrolysis stack is operating with lower efficiency than that of the reference operating state. In this case, the controller 40 controls the converter unit 10 and/or the rectifier unit 30 to decrease the direct current supplied to the electrolysis stack so that the actual operating point of the electrolysis stack moves from point P2 down to point P2′ (see the hollow triangle point in FIG. 17) on the curve L(k).

It is seen that the control of powering an electrolysis stack based on a state of the electrolysis stack can be realized by using a reference curve including a slope and one or more reference operating points of the electrolysis stack on the reference curve.

It is noted that the slope of the reference curve can be adjusted. For example, referring to FIG. 17, the reference curve can also be implemented as a curve L1(k1) with a slope k1 or a curve L2(k2) with a slope k2. The absolute value of the slope k1 is greater than that of the slope k, and the absolute value of the slope k2 is further greater.

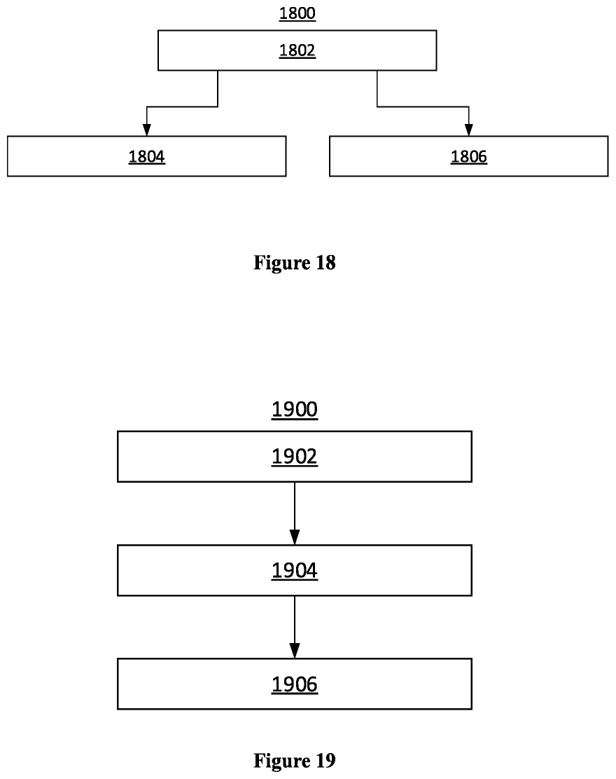

FIG. 18 is a flow chart of a method 1800 for controlling the power supply system 100 to power the electrolysis device 200 according to yet another embodiment of the present disclosure.

Referring to FIG. 18, at block 1802, information on hydrogen production is obtained. The information can include an actual hydrogen production of each electrolysis stack, a target hydrogen production of each electrolysis stack, an actual total hydrogen production of all the electrolysis stacks, and a target total hydrogen production of all the electrolysis stacks.

In an example, the powering of each electrolysis stack is independently controlled, so that the hydrogen production of each electrolysis stack is adjusted to reach its target hydrogen production respectively. In this case, the method 1800 proceeds to block 1804. At block 1804, the controller 40 controls the converter unit 10 and/or the rectifier unit 30 to adjust a direct current supplied to each electrolysis stack, so that the actual hydrogen production of each electrolysis stack is equal to or maximally close to its target hydrogen production.

In another example, the actual total hydrogen production of all the electrolysis stacks is controlled, so that the actual total hydrogen production is adjusted to the target total hydrogen production. In this case, the method 1800 proceeds to block 1806. At block 1806, the controller 40 controls the converter unit 10 and/or the rectifier unit 30 to adjust the supplied currents to one or more electrolysis stacks, so that the actual total hydrogen production is equal to or maximally close to the target total hydrogen production.

Reference of examples of controlling the converter unit and/or the rectifier unit at blocks 1804 and 1806 can be made to the relevant description above, and details are not repeated here.

FIG. 19 is a flow chart of a method 1900 for controlling the power supply system 100 to power the electrolysis device 200 according to yet another embodiment of the present disclosure.

Referring to FIG. 19, at block 1902, the controller 40 determines whether any of the plurality of electrolysis stacks are faulty. For example, the controller 40 determines whether a short circuit fault occurs at any of the electrolysis stacks based on the measured currents.

At block 1904, if it is determined that one of the plurality of electrolysis stacks is a faulty electrolysis stack, the controller 40 controls the converter unit 10 and/or the rectifier unit 30 to cut off the load current in the branch circuit for powering the faulty electrolysis stack. For example, the load current can be cut off by controlling controllable power electronic devices of the converter unit 10 and/or the rectifier unit 30.

At block 1906, in the case that the load current has been cut off, the controller 40 controls a branch switch coupled to the branch circuit to switch off such that the faulty electrolysis stack is disconnected from the power supply system 100. Alternatively, the branch switch can also be off manually.

The switching off method 1900 has the advantage of a high level of safety, since the high load current has been cut off before operating the branch switch.

Compared with using a 50 Hz transformer in prior art solutions, the switching off method implemented in the power supply system 100 including an MFT with a frequency of about 400 Hz has the advantage of fast disconnecting speed, because the timing for cutting off the load current will come much more quickly. In addition, operating power electronic devices to cut off the load current has the advantage of fast disconnecting speed.

In addition, in the case that the power supply system adopts the single-phase topology shown in FIG. 11 or 12, a zero-crossing point is detected, and then the phase current is cut off at the detected zero-crossing point.

In addition, in an example where an on-load switch such as a circuit breaker is used to implement the switching off method, if a failure occurs in a converter or a rectifier, the branch circuit of the faulty converter or faulty rectifier can be disconnected by operating the on-load switch. Then, the faulty converter or faulty rectifier can be maintained or replaced.

An example of the disclosure provides a machine readable medium comprising instructions stored in a memory and executed by one or more processors to carry out the above-mentioned methods.

It is noted that all the operations described above are merely exemplary, and the disclosure is not limited to any operations or sequence orders of these operations, and should cover all other equivalents under the same or similar concepts.

Processors are described in connection with various systems and methods. These processors can be implemented using electronic hardware, computer software, or any combination thereof. Whether these processors are implemented as hardware or software will depend on the specific application and the overall design constraints imposed on the system. By way of example, a processor, any portion of a processor, or any combination of processors presented in this disclosure may be implemented as a microprocessor, a micro-controller, a digital signal processor (DSP), a field programmable gate array (FPGA), a programmable logic device (PLD), state machine, gate logic, discrete hardware circuitry, and other suitable processing components configured to perform the various functions described in this disclosure. The functions of a processor, any portion of a processor, or any combination of processors presented in this disclosure may be implemented as software executed by a microprocessor, a micro-controller, a DSP, or other suitable platforms.

Software should be interpreted broadly to represent instructions, instruction sets, code, code segments, program code, programs, subroutines, software modules, applications, software applications, software packages, routines, subroutines, objects, running threads, processes, functions, and the like. Software can reside on a non-transitory computer-readable medium. Such non-transitory computer-readable medium may include, for example, a memory, which may be, for example, a magnetic storage device (e.g., a hard disk, a floppy disk, a magnetic strip), an optical disk, a smart card, a flash memory device, a random access memory (RAM), a read only memory (ROM), a programmable ROM (PROM), an erasable PROM (EPROM), an electrically erasable PROM (EEPROM), a register, or a removable disk. Although a memory is shown as being separate from the processor in various aspects presented in this disclosure, a memory may also be internal to the processor (e.g., a cache or a register).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalent transformations to the elements of the various aspects of the disclosure, which are known or to be apparent to those skilled in the art, are intended to be covered by the claims.

1. A power supply system for powering an electrolysis device, comprising:
a converter unit comprising one or more converters;
a transformer unit comprising one or more transformers coupled with the converter unit;
a rectifier unit comprising a plurality of rectifiers, each rectifier being coupled between one of the one or more transformers and one of a plurality of electrolysis stacks of the electrolysis device; and
a controller configured to control the converter unit and/or the rectifier unit to adjust a direct current supplied to at least one of the plurality of electrolysis stacks.

2. The power supply system of claim 1, wherein the controller is configured to:
obtain state parameters indicative of states of at least two electrolysis stacks of the plurality of electrolysis stacks; and
control the converter unit and/or the rectifier unit to adjust a direct current supplied to each of the at least two electrolysis stacks based on the obtained state parameters to balance the states of the at least two electrolysis stacks.

3. The power supply system of claim 2, wherein controlling the converter unit and/or the rectifier unit to balance the states of the at least two electrolysis stacks includes:
controlling the converter unit and/or the rectifier unit to reduce the direct current supplied to an electrolysis stack having a voltage higher than an upper limit voltage of a predetermined voltage range; and
controlling the converter unit and/or the rectifier unit to increase the direct current supplied to an electrolysis stack having a voltage lower than a lower limit voltage of the predetermined voltage range.

4. The power supply system of claim 2, wherein controlling the converter unit and/or the rectifier unit to balance the states of the at least two electrolysis stacks includes:
controlling the converter unit and/or the rectifier unit to reduce the direct current supplied to an electrolysis stack having the highest voltage among the plurality of electrolysis stacks; and
controlling the converter unit and/or the rectifier unit to increase the direct current supplied to an electrolysis stack having the lowest voltage among the plurality of electrolysis stacks.

5. The power supply system of claim 2, wherein the controller is configured to:
obtain a reference curve having one or more reference operating points of the at least one electrolysis stack; and
in the case that an actual operating point of the at least one electrolysis stack deviates from a corresponding reference operating point of the one or more reference operating points on the reference curve, control the converter unit and/or the rectifier unit such that the actual operating point coincides with the corresponding reference operating point.

6. The power supply system of claim 5, wherein the reference curve is one of:
a current-voltage reference curve;
a current-power reference curve;
a current-operating efficiency reference curve;
a current-aging degree reference curve; or
a current-aging speed reference curve.

7. The power supply system of claim 1, wherein the controller is configured to:
obtain an operating efficiency of each electrolysis stack;
compare the operating efficiency of each electrolysis stack to an operating efficiency threshold;
control the converter unit and/or the rectifier unit to reduce the direct current supplied to an electrolysis stack operating at an operating efficiency less than the operating efficiency threshold; and
control the converter unit and/or the rectifier unit to increase the direct current supplied to an electrolysis stack operating at an operating efficiency greater than the operating efficiency threshold.

8. The power supply system of claim 7, wherein the controller is further configured to:
control the converter unit and/or the rectifier unit such that the direct current is reduced at a predetermined decreasing slope; and
control the converter unit and/or the rectifier unit such that the direct current is increased at a predetermined increasing slope.

9. The power supply system of claim 8, wherein the controller is configured to:
increase the absolute value of the decreasing slope as the difference between the operating efficiency and the operating efficiency threshold increases; and
decrease the absolute value of the increasing slope as the difference between the operating efficiency and the operating efficiency threshold decreases.

10. The power supply system of claim 7, wherein the controller is configured to control the converter unit and/or the rectifier unit to reduce or increase the supplied current such that the total hydrogen production efficiency of the plurality of electrolysis stacks is maximized.

11. The power supply system of claim 7, wherein the operating efficiency threshold is a predetermined fixed value.

12. The power supply system of claim 7, wherein the controller is configured to:
take a predetermined initial value of the operating efficiency threshold as a starting point; and
dynamically adjust the operating efficiency threshold, so that the operating efficiency threshold is always between the best operating efficiency and the worst operating efficiency of operating efficiencies of the plurality of electrolysis stacks.

13. The power supply system of claim 1, wherein the controller is configured to:
obtain an aging degree of each electrolysis stack; and
control the converter unit and/or the rectifier unit to reduce the direct current supplied to an electrolysis stack having an aging degree higher than an aging degree threshold.

14. The power supply system of claim 13, wherein the aging degree threshold is a predetermined fixed value.

15. The power supply system of claim 13, wherein the controller is configured to:
take a predetermined initial value of the aging degree threshold as a starting point; and
dynamically adjust the aging degree threshold, so that the aging degree threshold is always between an aging degree indicative of most seriously aging and an aging degree indicative of slightest aging among the plurality of electrolysis stacks.

16. The power supply system of claim 1, wherein the controller is configured to:
calculate a service life of each electrolysis stack in real time; and
control the converter unit and/or the rectifier unit such that the service life of each electrolysis stack is almost the same.

17. The power supply system of claim 1, wherein the controller is configured to:
obtain an actual hydrogen production and a target hydrogen production of the at least one electrolysis stack; and
control the converter unit and/or the rectifier unit to adjust the direct current supplied to the at least one electrolysis stack, so that the actual hydrogen production of the at least one electrolysis stack is equal to the target hydrogen production of the at least one electrolysis stack.

18. The power supply system of claim 1, wherein the controller is configured to:
obtain an actual total hydrogen production and a target total hydrogen production of the plurality of electrolysis stacks; and
control the converter unit and/or the rectifier unit to adjust a direct current supplied to each of the plurality of electrolysis stacks, so that the actual total hydrogen production of the plurality of electrolysis stacks is equal to the target total hydrogen production of the plurality of electrolysis stacks.

19. The power supply system of claim 1, further comprising a switch unit, wherein the switch unit comprises a plurality of branch switches, and each branch switch is arranged in one of a plurality of branch circuits for powering one of the plurality of electrolysis stacks.

20. The power supply system of claim 19, wherein each branch switch is coupled between the transformer unit and one of the plurality of rectifiers, or between one of the plurality of rectifiers and one of the plurality of electrolysis stacks.

21. The power supply system of claim 19, wherein the controller is configured to:
determine whether any of the plurality of electrolysis stacks is faulty;
if it is determined one of the plurality of electrolysis stacks is faulty, control the converter unit and/or the rectifier unit to cut off the load current in a branch circuit for powering the faulty electrolysis stack; and
in the case that there is no load current in the branch circuit, control the branch switch in the branch circuit to switch off.

22. The power supply system of claim 1, wherein the transformer unit comprises one transformer having a primary winding and a plurality of secondary windings, the primary winding being coupled to the converter unit and each of the plurality of secondary windings being coupled to one of the plurality of rectifiers.

23. The power supply system of claim 1, wherein the transformer unit comprises a plurality of transformers each of which is coupled between the converter unit and one of the plurality of rectifiers, and the operating frequency range of each transformer is 100Hz~30 kHz.

24. The power supply system of claim 1, wherein the converter unit comprises a plurality of converters each of which is coupled to one of the plurality of rectifiers via the transformer unit.

25. The power supply system of claim 1, wherein each of the plurality of rectifiers is implemented by one of:
a diode-based rectifier;
a thyristor-based rectifier;
a diode-based rectifier and a DC-DC converter connected in series with the diode-based rectifier; or
a thyristor-based rectifier and a DC-DC converter connected in series with the thyristor-based rectifier.

26. A method for controlling a power supply system to power an electrolysis device, the power supply system comprising a converter unit, a transformer unit coupled with the converter unit, and a rectifier unit comprising a plurality of rectifiers, each rectifier being coupled between the transformer unit and one of a plurality of electrolysis stacks of the electrolysis device, the method comprising:
controlling the converter unit and/or the rectifier unit to adjust a direct current supplied to at least one of the plurality of electrolysis stacks.

27. A controller for controlling a power supply system to power to an electrolysis device, comprising one or more processors configured to execute the method of claim 26.
